(19) United States
(12) Patent Application Publication
(10) Pub. No.: US 2006/0120064 A1
(43) Pub. Date: Jun. 8, 2006

(54) Illuminated fan blade

(76) Inventor: Kenneth Dean McElhannon, Pickens, SC (US)

Correspondence Address: John B. Hardaway, III;NEXSEN PRUET, LLC, P.O. Box 10107, Fed. Sta., Greenville, SC, 29603-0107, US

(21) Appl. No.: 11/006,028

(22) Filed: Dec. 7, 2004

(51) Int. Cl. F21V 8/00

(52) U.S. Cl. 362/96

(57) ABSTRACT

A fan or other rotating device is illuminated using light projected from LD's mounted in a circle about the axis. The light colors may be the same or different and the device may be used for basic illumination or decorative effect.

### FIELD OF THE INVENTION

This invention is an illuminated plastic blade for a fan, especially an overhead fan.

### BACKGROUND AND PRIOR ART

Numerous attempts have been made to combine lights and fan blades, especially to illuminate ceiling fans for both area lighting and decorative purposes

U.S. Pat. No. 5,028,208 to Kendregan et al., discloses a ceiling fan with neon lights attached to the periphery of each blade.

U.S. Pat. No. 5,072,341 to Huang discloses a number of light bars which rotate about their axis but not about the axis of the fan blade.

U.S. Pat. No. 5,082,422 to Wang discloses fan blades with multiple LED's directed perpendicularly to the flat surface of the blade.

U.S. Pat. No. 5,224,830 to Wang has holographic patterns secured to each blade which respond to light directed toward the blade from below.

U.S. Pat. No. 5,437,540 to Blocker et al. places neon lamps within hollow plastic transparent blades.

U.S. Pat. No. 6,019,479 to Barker discloses fan blade covers with designs illuminated by a strobe light below the fan blades.

U.S. Pat. No. 6,036,331 to Acquisto is directed to fan blades with a multi-point light source running across the midline of the blade. The light sources include bulbs and LED's.

U.S. Pat. No. 6,193,384 to Stein discloses a rim around the fan blades which holds LED's in selected patterns.

U.S. Pat. No. 6,213,617 to Barker employees strobe lights to “stop” fan blades.

U.S. Pat. No. 6,367,942 to Bauer discloses the use of chemiluminescent light sources hanging from the blades to obtain unusual lighting effects.

Published Patent Application U.S. 2003/0133311 to Robertson et al., uses LED's to decorate the down rod of a fan but not the blade.

### BRIEF SUMMARY OF THE INVENTION

This invention employs ultra bright light emitting diodes (LED's), preferably controllable LED's, in a variety of colors to illuminate the core of a fan blade or a light pipe on a blade surface. One or more channels are formed in a fan blade and an LED projected through its length. The plastic from which the blade is formed may be clear and colorless, translucent and colorless clear and colored or translucent and colored. More than one LED may be used in each blade and they may be turned on or off in any sequence, including randomly.

The fan may be placed in any orientation although a ceiling type fan in thought to be preferred from the standpoint of light distribution and novelty effects.

### BRIEF DESCRIPTION OF THE DRAWINGS

FIG. 1 shows a single fan blade according to an embodiment of this invention.

FIG. 2 is an obverse view of a blade iron according to an embodiment of this invention.

FIG. 3 is a reverse view of a blade iron according to an embodiment of this invention.

FIG. 4 illustrates the geometric relationships between fan hub, laser diode, blade arm, blade and light pipe according to an embodiment of this invention.

FIG. 5 illustrates one embodiment of a round LED circuit board, according to this invention.

FIG. 6. is an exploded view of the components of this invention.

### DETAILED DESCRIPTION OF THE INVENTION

This invention takes advantage of the availability of high intensity LEDS's to provide new utility to ceiling fans and to introduce interesting lighting effects to ceiling fans and other rotating blade fans.

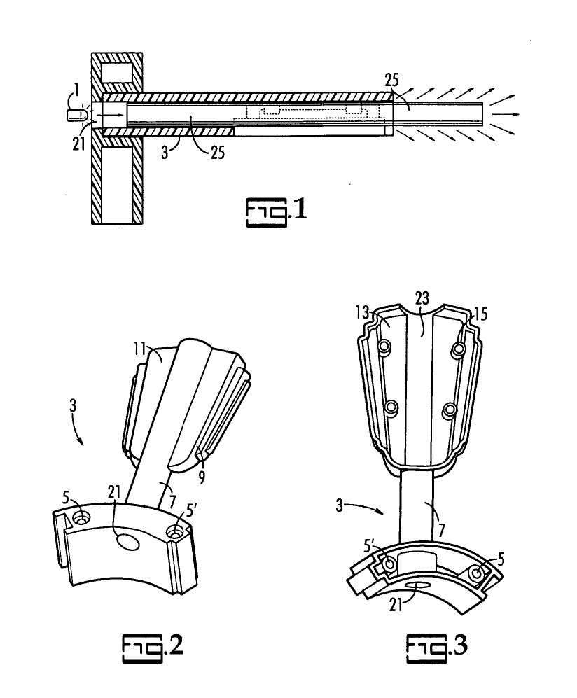

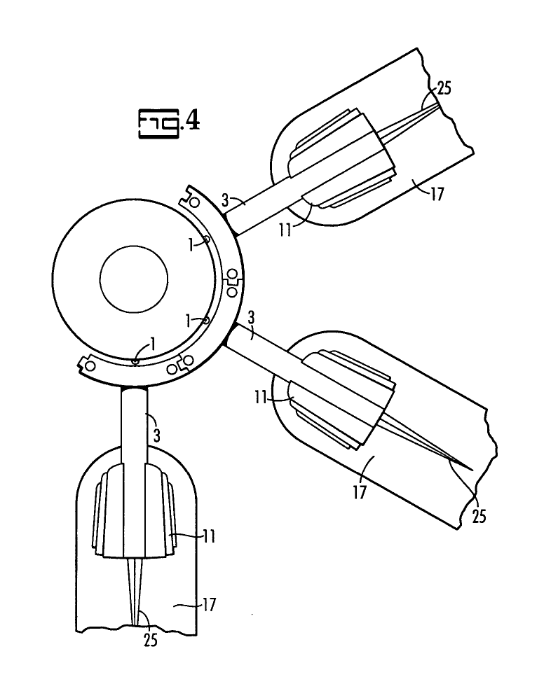

FIGS. 1-4 depict a first embodiment of the invention. As shown in FIG. 1, an LED 1 projects a beam of light though a blade iron 3 having an accurate base, a plurality of through holes 5, 5′, a projecting arm 7 and a mounting bracket 9 having an obverse face 11 and a reverse face 13. Reverse face 13 has means 15 for attaching a fan blade 17. A through hole 21 in the base is continued through arm 7 and becomes channel 23 in the mounting bracket. A transparent medium such as an acrylic plastic tube or light pipe 25 extends from the base of through hole 21 through the arm 7 and channel 23 and projects outwardly. A fan blade 17 attaches to mounting bracket 9 and overlies the light pipe for the length of the light pipe. Light projected from LED 1 is visualized as a lighted stripe on blade 17.

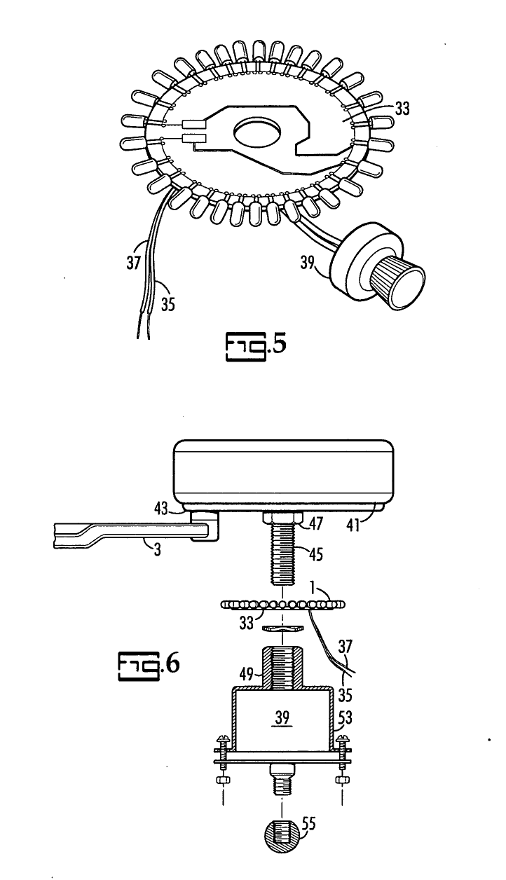

As shown in FIG. 5, within the circle defined by the blade iron bases, is a circular LD circuit board 31 having a plurality of high intensity LED's 1 which may be the same or different colors mounted on an I.C. base plate 33. A preferred arrangement is that wherein there are three colors arranged in repeating order, the number of repetitions being the number of blades so that the projected colors on each blade is the same. Variations on this theme are left to the imagination of those skilled in the art.

The I.C. 33 is powered through leads 35, 37 connected to a 12 volt DC transformer 39 to house a-c power through a down rod and motor shaft, as is conventional for lighting suspended below a ceiling fan.

The fan blades 27 may be formed in a variety of shapes and from a variety of materials. Conventional would be a solid or wicker blade in any choice of colors. Clear plastic, usually acrylic, blades may be used as a projection light pipe so that the entire blade is illuminated.

FIG. 6 is an exploded view of one method for assembling the components of this invention. Motor 41 is suspended from a conventional down rod (not shown). The “inside out” motor drives a hub 43 to which blade irons 3 are secured. A stationary suspensory shaft 45 projects downwardly as a functional extension of the down rod. An LED I.C. Board 33 slides over the shaft 45 and is located by a stop nut 47 and a threaded nacelle 49 of a housing which contains transformer 39 and a switch held in place by a decorative lower bracket which may include a cap nut 57. Wires 35, 37 connect to switch from the I.C.

Only when one color LED is used, the switch has only two positions. When multiple color LED's are used, the switch becomes a multiple position switch and the number of wire 35, 37 is increased appropriately.

Optionally, operation of the fan and lights may be controlled remotely using a radio frequency remote control transmitter such as that disclosed in U.S. Pat. No. 6,015,274 to Bias et al. When the remote control option is employed, the transformer and switching system maybe relocated to a housing above the motor.

Although the primary use for this invention may be found in ceiling fans. The concept is applicable to vertical fans, amusement devices such as wheels of chance, rotating dance floors, and advertising signs.

The invention has been described in terms of a preferred embodiment that is not limitative of the scope of the invention. Modifications and additions apparent to one of skill in the art are included within the spirit and scope of the invention.

The lighted fan blade according to this invention provides illumination for pavilions, public rooms and homes and serves as an amusement device in bars, restaurants and dance clubs.

1. A fan comprising a motor with a rotor outside a starter, a plurality of blades attached to said rotor through a plurality of blade irons, a plurality of LED's mounted on a circuit board inside the circle of the blade irons wherein a light pipe passes through said blade irons to direct light from said LED's to the surface of said blade.

2. A fan according to claim 1 wherein all said LED's project light of the same color.

3. A fan according to claim 1 wherein said LED's project a plurality of colors.

4. A fan according to claim 1 wherein at least two sets of colored LD's are placed in alternating order on said circuit board and said LED's of one color are light at the same time.

5. A fan according to claim 3 wherein LED's are lighted at random and multiple colors are projected at random on the blades.

6. A fan according to claim 1 wherein the fan motor and LED's are separately controlled by a radio frequency controller device.

7. A rotating device having arrayed about its axis, a plurality of LED's projecting radially through a transparent or translucent material.
